(19) United States
(12) Patent Application Publication
(10) Pub. No.: US 2017/0191454 A1
(43) Pub. Date: Jul. 6, 2017

(54) Merge Manifold Spacer

(71) Applicant: Paul Anthony Klyczek, Spring Hill, FL (US)

(72) Inventor: Paul Anthony Klyczek, Spring Hill, FL (US)

(21) Appl. No.: 15/398,687

(22) Filed: Jan. 4, 2017

Related U.S. Application Data
(60) Provisional application No. 62/275,026, filed on Jan. 5, 2016.

(51) Int. Cl. F02M 35/10; F02M 35/104; F02M 7/10

(52) U.S. Cl. CPC F02M 35/10144; F02M 7/10; F02M 35/104

(57) ABSTRACT

In some embodiments, the present invention comprises a Merge Manifold Spacer used in conjunction with a single venturi carburetor or a single venturi throttle body and a intake manifold on an internal combustion engine. In some embodiments, the Merge Spacer Manifold has a top and bottom opening, interior veining, and a blend radius built into the interior walls.

### FIELD OF INVENTION

This invention relates to how the air, fuel, oxidizer mixture is introduced into an intake manifold of an internal combustion engine, in conjunction with a single venturi carburetor or single venturi throttle body, and more precisely facilitates the merging between a basic intake manifold flange and a single venturi carburetor or single venturi throttle body.

### BACKGROUND

Internal combustion engines, when used in high performance applications such as drag racing and several other racing applications, introduce a mixture of fuel and/or air from a carburetor or a throttle body and a mixture of fuel and/or an oxidizer from a manifold spacer, that may be placed between a carburetor or a throttle body and the intake manifold, to increase horsepower. The two mixtures are pulled through the intake manifold plenum, through the individual runners of the intake manifold, through the cylinder port runners and the mixture is then ignited in the cylinder. This intake charge flow, consisting of the air, fuel, oxidizer mixture, is affected by the size and shape of the carburetor or throttle body, the oxidizer mixture manifold spacer, and the intake manifold.

When using a manifold spacer to supply a mixture of oxidizer and fuel to an internal-combustion engine, in conjunction with a single venturi carburetor or single venturi throttle body, the carburetor or throttle body blade protrudes into the fuel/oxidizer manifold spacer or into the manifold plenum causing blade interference and the intake charge flow is altered. Current available manifold spacers and or intake manifolds impair volumetric efficiency; have clearance issues, passage placement also causes uneven distribution when introducing the air fuel mixture into the fuel oxidizer mixture. This results in loss of horsepower and improper ignition including, but not limited to, parts damage and engine failure. The main cause of horsepower loss and improper ignition when using a combination of a single venturi carburetor or a single venturi throttle body, a fuel/oxidizer manifold spacer, and a basic intake manifold flange, is that all three components differ in size and shape. The lack of boundary layer conformity, from the single venturi carburetor or single venturi throttle body to the intake manifold plenum, causes the air/fuel/oxidizer mixture to separate leading to improper ignition and lack of combustion. Therefore, a new manifold spacer which can facilitate proper ignition and combustion performance is needed in the field.

### BRIEF SUMMARY OF THE INVENTION

In some embodiments, the present invention is a manifold spacer inserted between the outlet of a single venturi carburetor or a single venturi throttle body and the inlet of an intake manifold. The top opening of the manifold spacer is configured in size and shape to avoid interference with the blade of a single venturi carburetor or single venturi throttle body. The main internal area of the manifold spacer is uniquely configured to maximize and control the fuel oxider mixture/intake charge flow. The bottom opening of the manifold spacer is configured in size and shape to create a smooth transition from a single venturi carburetor or a throttle body outlet into the intake manifold plenum preventing the air/fuel/oxidizer mixture from separating in order to lessen improper combustion.

It is one object of this invention to provide a smooth transition from a single venturi carburetor or single venturi throttle body to the intake manifold flange, provide a means for better mixing, distributing, and controlling the air, fuel, oxidizer mixture, solve the parts interference problem and increase engine combustion thus increasing horsepower output.

### BRIEF DESCRIPTION OF THE DRAWINGS

FIG. 1 Illustrates one example of the Merged Manifold Spacer placed between a single venturi carburetor or throttle body and an intake manifold.

FIG. 2 is a top face view of one example of the Merged Manifold Spacer illustrating the opening shape, the mounting holes, the idle fuel transfer slots, and the internal veins.

FIG. 3 is a bottom face view of one example of the Merged Manifold Spacer illustrating the opening shape, the mounting holes, and the internal veins.

FIG. 4 is an isometric bottom view of one example of the Merged Manifold Spacer illustrating the idle slots, the internal wall blend radius, and the internal veins.

FIG. 5 is a top face view of one example of the Merged Manifold

Spacer showing the addition of oxidizer/fuel manifolds.

FIG. 6 is a top facing view of one example of the Merged Manifold Spacer showing the addition of a secondary cross style oxidizer/fuel manifolds.

FIG. 7 is an isometric bottom view of one example the Merged Manifold Spacer illustrating the fuel exit ports, the oxidizer exit ports, and the manifold entry channel that feeds the fuel and oxidizer exit ports.

### DETAILED DESCRIPTION AND BEST MODE OF IMPLEMENTATION

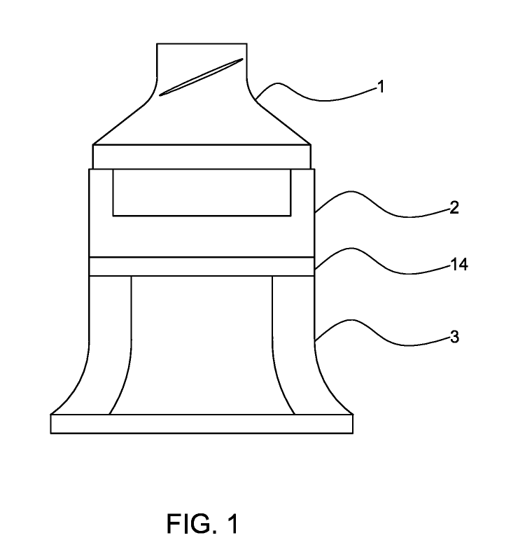

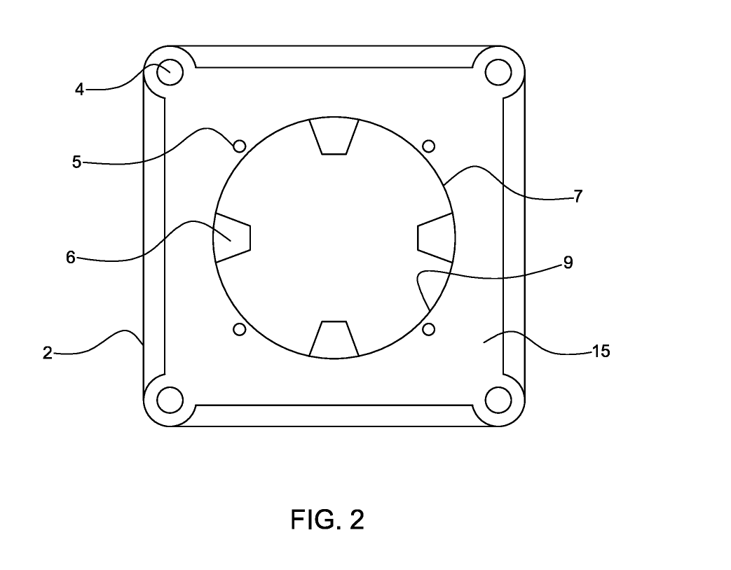

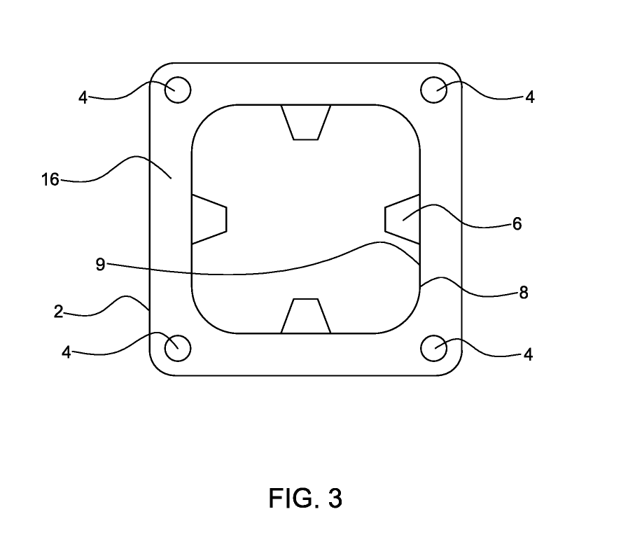

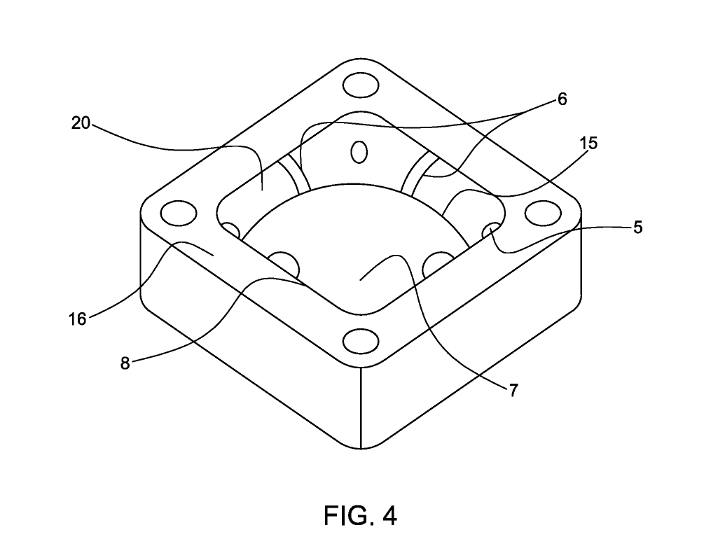

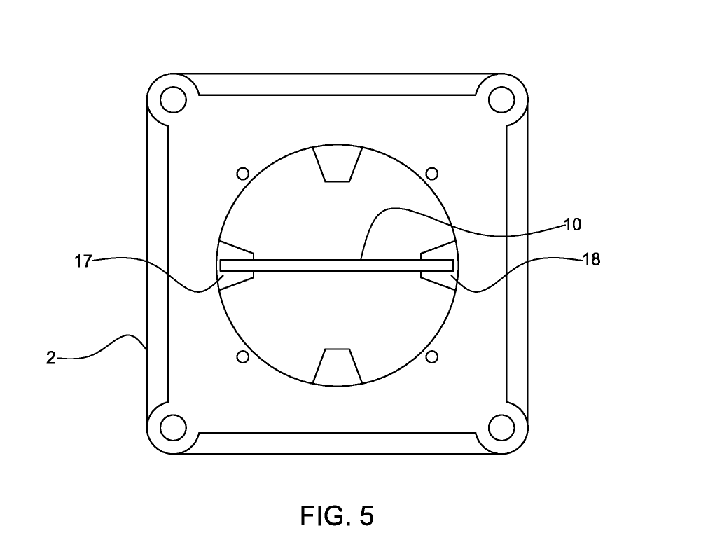

The present invention shall be described by way of non-limiting examples with reference to FIGS. 1, 2, 3, and 4 with additional consideration given to FIGS. 5, 6 and 7. FIG. 1 is a side view of one example of the Merged Manifold Spacer 2 installed between a single venurti carburetor or a single venturi throttle body 1 and an intake manifold flange 14. The Merged Manifold Spacer 2 could be made from various materials, including but not limited to, aluminum, plastic, resin, phoenelic, metal or other suitable material and may range in height from 12 mm to 80 mm or other suitable sizes and dimensions. FIG. 2 is a detailed top view of one example of the manifold spacer 2 illustrating the shape of the top opening 7, the mounting holes 4, the inside wall veins 6 and the idle fuel transfer slots 5. FIG. 3 is a bottom face view of one example of the Merged Manifold Spacer 2 illustrating the bottom opening 8 shape, the mounting holes 4, and the internal veins 6. FIG. 4 is an isometric bottom view of one example of the Merged Manifold Spacer 2 illustrating the idle slots 5, the internal wall blend radius 20, and the internal veins 6.

FIG. 1 illustrates the use of the Merged Manifold Spacer 2 when placed between a single venturi carburetor or single venturi throttle body 1 and attached to the plenum flange 14 of an intake manifold 3. The top part of the Merged Manifold Spacer center opening 7, as shown in the embodiment of FIG. 2, is configured to the size and shape of a single venturi carburetor or a single venturi throttle body range in diameter from 90 mm to 115 mm. Mounting holes 4 are drilled through the material to coincide with the bolt pattern installed on a corresponding intake manifold and may vary in size and position on the Merged Manifold Spacer depending on the intake manifold flange pattern and the intake manifold plenum dimension used. Idle Fuel Transfer Slots 5 are drilled into the top of the Merged Manifold Spacer to coincide with the idle transfer slots on a single venturi carburetor and may vary in size and position. The Idle Transfer Slots 5 are further shown in FIG. 4 where they may exit the interior side wall of the Merged Manifold Spacer. Veins 6 are shown by example in the top view, FIG. 2, of the Merged Manifold Spacer 2 as they are installed into the interior wall 9 from the top flange of the spacer 15 to the bottom flange of the spacer 16 as shown in FIG. 4.

FIG. 3 illustrates the bottom view of one example of the Merged Manifold Spacer. The bottom opening 8, of the Merged Manifold Spacer 2 in this embodiment, is configured in size and shape to conform to commercially available intake manifold plenums or to custom intake manifold plenums. The mounting holes 4 exits are shown on FIG. 3 and may vary in size and position on the Merged Manifold Spacer 2 depending on the intake manifold flange pattern and the intake manifold plenum dimension used. Veins 6 are shown in the bottom view of FIG. 3 of the Merged Manifold Spacer 2 as they are installed into the interior wall 9 of the spacer from the top flange 15 as shown in FIG. 2 of the spacer 2 to bottom flange 16 of the spacer. Shown in FIG. 3.

FIG. 4 is an isometric bottom view of one example of the Merged Manifold Spacer illustrating the internal wall Blend Radius 20 from the bottom opening 8 of the spacer 2 to the top opening 7 of the spacer creating a unified path for the intake charge flow. FIG. 4 further shows the Idle Transfer Holes 5 as the may exit into the manifold spacer interior wall. The Veins 6 are illustrated as being installed from the bottom flange of the spacer to the top flange of the spacer, this is to align the intake charge and promote swirl suppression.

FIG. 5 is a top view of one example of the Merged Manifold Spacer 2 illustrating the addition of an Oxidizer/Fuel Manifold Spray Bar 10 installed through the side wall 17 and ending at the opposite side wall 18 of the spacer 2. The Oxidizer/Fuel Manifold Spray Bar 10 can be installed at any position from top to bottom and the spacer is not limited to a single Oxidizer/Fuel Manifold Spray Bar. Two or more Oxidizer/Fuel Manifold Spray Bars 10 may be installed in various configurations, stacked on top of one another, angled, or crossed. This is a general representation as shown by example in the figures. The Merged Manifold Spacer 2 is not limited to a single configuration or format.

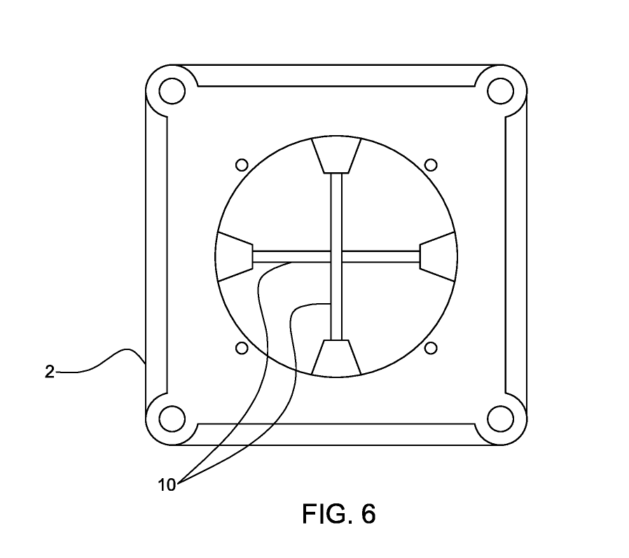

FIG. 6 is a top view of one example of the Merged Manifold Spacer 2 with two Oxidizer/Fuel Manifold Spray Bars 10 installed in a crossbar pattern. The Oxidizer/Fuel Manifold Spray Bar 10 can be made of various materials such as brass, aluminum or stainless steel or other suitable material.

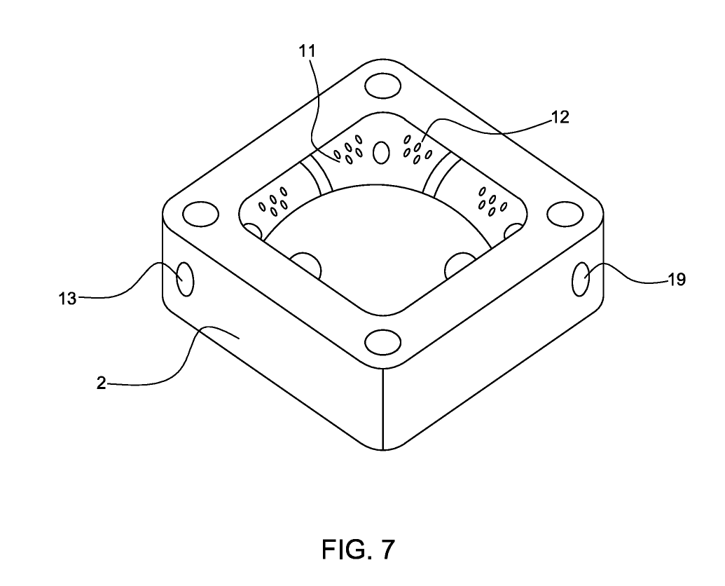

FIG. 7 is an isometric bottom view of one example of the Merged Manifold Spacer 2 with the addition of Fuel Exits 11, Oxidizer Exits 12, Oxidizer Entry Channel 13 and Fuel Entry Channel 19. The Merged Manifold Spacer 2 can be configured with Fuel Entry 13 and Oxidizer Entry 19 to supply a fuel and oxidizer mixture into the intake charge without the need of a secondary manifold.

What is claimed is:

1. A Merge Manifold Spacer inserted between the outlet of a single venturi carburetor or a single venturi throttle body and the inlet of an intake manifold consisting of:
a. a throttle body flange opening
b. an intake manifold flange opening
c. a central through passageway

2. The merge manifold spacer as defined in claim 1 further comprising a throttle body flange configured for a single venturi carburetor or single venturi throttle body and may range in size from 90 mm to 115 mm or other suitable sizes.

3. The merge manifold spacer as defined in claim 1 further consists of a blend wall radius of the central through passageway connecting the throttle body flange to the intake manifold flange of dissimilar shape from the throttle body flange but may range in size and shape.

4. The merge manifold spacer as defined in claim 1 further consists of interior passageway wall veins from throttle body flange to intake manifold flange of suitable or appropriate amounts.

5. The merge manifold spacer as defined in claim 1 further consists of idle fuel transfer slots in configuration with a single venturi carburetor.

6. The merge manifold spacer as defined in claim 1 further contains a mounting flange bolt pattern consistent in configuration single venturi carburetor or single venturi throttle body.

7. The merge manifold spacer as defined in claim 1 further comprising of an “o” ring groove located on either or both the throttle body flange and/or the intake manifold flange.

8. The merge manifold spacer as defined in claim 1 further contains an oxidizer/fuel manifold spray bar that can be installed at any position from top to bottom.

9. The merge manifold spacer as defined in claim 1 further contains two oxidizer/fuel manifold spray bars installed in a crossbar pattern can be installed at any position from top to bottom

10. The merge manifold spacer as defined in claim 1 further contains fuel exit channels, oxidizer exit channels, fuel entry channels, and oxidizer entry channels to supply a fuel and oxidizer mixture into the intake charge without the need of a secondary manifold/spray bar. These channels can be installed at any position from top to bottom.
